(19) United States
(12) Patent Application Publication
(10) Pub. No.: US 2026/0357816 A1
(43) Pub. Date: Nov. 12, 2026

(54) Compressor

(71) Applicant: BMTS Technology GmbH & Co. KG, Stuttgart (DE)

(72) Inventors: Daniel Schulze, Kernen (DE); Ivo Sandor, Kirhcheim (DE); Alexander H. Taylor, Stuttgart (DE); Pavan Naik, Stuttgart (DE); Aneel Singh, Stuttgart (DE); Bojan Sekutkovski, Stuttgart (DE); Nathan Bixler, Stuttgart (DE); Borislav Jelisavac, Stuttgart (DE); Philipp Blasch, Stuttgart (DE); Joseph Wichlinski, Stuttgart (DE); Nisar Al-Hasan, Stuttgart (DE)

(21) Appl. No.: 19/125,626

(22) PCT Filed: Nov. 10, 2023
(86) PCT No.: PCT/EP2023/081392

§ 371 Date: Apr. 29, 2025

(30) Foreign Application Priority Data
Nov. 10, 2022 (EP) 22206677.1

(51) Int. Cl. F04D 29/42; F04D 17/10; F04D 29/28

(52) U.S. Cl. CPC F04D 29/4206; F04D 17/10; F04D 29/284; F05D 2250/231

(57) ABSTRACT

The invention relates to a compressor having a rotatably mounted impeller (10), wherein the impeller (10) has a radially inner inflow area (11) and a radially outer outflow area (14), wherein the inflow area (11) is connected to the outflow area (14) via flow passages (15), which extend from the inflow area (11) to the outflow area (14), wherein the flow passages (15) each have a flow cross-section measured in the circumferential direction of the impeller (10), wherein the flow passages (15) have a passage length extending from the inflow area (11) to the outflow area (14), and wherein the flow passages (15) have a passage volume, which results from the flow cross-section and the passage length. To simultaneously achieve high pressure ratios with such a compressor at a very low diameter-specific throughput, provision is made in accordance with the invention for the volume occupied by the impeller (10) to be at least three times greater than the sum of the passage volumes of the flow passages (15), and/or for the angular spacing between two adjacent flow passages (15) measured in the circumferential direction of the impeller (10) at their flow inlet (15.1) in the inflow area (11) and/or at their flow outlet (15.2) in the outflow area to be at least 18°.

### COMPRESSOR

The invention relates to a compressor having a rotatably mounted impeller, wherein the impeller has a radially inner inflow area and a radially outer outflow area, wherein the inflow area is connected to the outflow area via flow passages, which extend from the inflow area to the outflow area, wherein the flow passages form flow outlets in the outflow area, which flow outlets are disposed spaced apart from the axis of rotation of the impeller, wherein the flow passages each have a flow cross-section extending in the circumferential direction of the impeller, wherein the flow passages have a passage length extending from the inflow area to the outflow area, and wherein the flow passages have a minimum flow passage cross-section along the passage length.

Compressors of various designs are known from the state of the art. An example of a turbo compressor is shown in EP 3 421 825 A1. These turbo compressors use an impeller that is held on a drive shaft. To generate a high pressure and a high mass flow, such compressors are designed as centrifugal compressors or radial compressors. The impeller takes in the air to be compressed centrally in the axial direction at its inflow area. The intake air then enters the flow passages via the flow inlets. The air is directed through the flow passages and conveyed radially outwards by the centrifugal forces acting on the rotating impeller. The compressed air therefore leaves the flow passage at the flow outlet.

For certain applications, it may now be necessary to provide a compressor that is suitable for generating high pressure, wherein only a small mass flow is made available, however.

For instance, in an application according to the invention, it may be necessary to provide a compressor that conveys a fluid at a very low mass flow (for instance in the range between 1-10 g/s), while at the same time maintaining high pressure ratios (differential pressure between the pressure in the outflow area and the inflow area in the range greater than 2 bar). These very special requirements can result from an application of the compressor according to the invention, in which ambient air is compressed to provide it to a cleaning system for lidar sensors operated using compressed air. The use of such a cleaning system can be provided, for instance, in autonomous vehicles having lidar sensors according to the invention.

The required pressure ratio can be achieved in conjunction with a turbo compressor together with a matching circumferential speed at the flow outlet of the impeller. Owing to the limited speed of the drive to around 100,000 rpm at which the impeller is driven (for instance by means of an electric motor), achieving these high pressure ratios is a challenge. The circumferential speed required can therefore only be implemented using large impeller outlet diameters. This results in a design having a very low diameter-specific throughput. This diameter-specific throughput of turbo compressors is essentially determined by the flow cross-section between the blades, the rotor hub and the casing contour and can only be varied to a limited extent in terms of design. When designing a very low diameter-specific flow rate, the passage cross-section has to be dimensioned accordingly small. In an extreme design, this results in an unfavorable ratio between the blade height and the clearance between the impeller tip and the casing.

Ultimately, the passage size cannot be smaller than the blade tip clearance. If the passage size is equal to the blade tip clearance in the borderline case, there is no more installation space left for the rotor blades and the compressor can no longer fulfill its function. If the diameter-specific throughput in this hypothetical case is still greater than the requirement, it is not technically possible to design a such a turbo compressor. Even before the borderline case described, a very unfavorable surface-to-volume ratio is achieved by reducing the blade height. As a result, there is virtually no free flow cross-section because of the boundary layers, precluding a technically sensible design.

The invention addresses the problem of providing a compressor, which has a very low diameter-specific throughput, but still achieves high pressure ratios and has a stable operating behavior.

This problem is solved in that the distance of the flow outlet, which is spaced apart furthest from the axis of rotation of the impeller, forms a radius for calculating a circular area, and in that the sum of the minimum flow passage cross-sections of all flow passages of the impeller in relation to this circular area is less than 0.01, preferably less than 0.008.

In other words it is:

$$\frac{min cross - sectional area of flow passages}{area resulting from maximum diameter} < 0.01 , \\ preferably < 0.008 .$$

In contrast to the known turbo compressors, in the solution according to the invention the flow through the impeller is limited due to the design of the flow passages. Only small mass flows are conveyed, wherein at the same time the compressor principle used in centrifugal compressors is retained to achieve the desired high pressure ratio.

The compression ratio can be adjusted by spacing the flow outlets apart from the axis of rotation. By adapting the flow passages (in terms of their number and cross-section), the flow rate can be adjusted. In this way, a scalability of the compressor is provided in both relevant dimensions (throughput and pressure ratio). The compressor can be operated in a reliable and stable manner. Stable operation of the compressor is characterized by the operating points being within the two operating limits (surge and choke lines).

For instance, the solution according to the invention can be used to create compressors, which can be used to achieve dimensionless speed characteristics σ in the range between 0.01 and 0.05, preferably between 0.01 and 0.03, wherein σ is calculated according to the formula:

σ=[\sqrt{V}×2×\sqrt{π}]÷[(Δp/ρ×2)^{3/4}]

The following terms apply:
Δp=differential pressure between the pressure in the outflow area and the pressure in the inflow area
ρ=density of the conveyed fluid
V=volume flow of the conveyed fluid.

Additionally or alternatively, for instance, the solution according to the invention can be used to create compressors, which can be used to achieve dimensionless diameter characteristic values δ in the range between 20 to 100, preferably 20 to 70, wherein δ is calculated according to the formula:

The following terms apply:

$$δ = \sqrt[4]{\frac{Δ p}{ρ} \times 2 \div {V}^{2}} \times \sqrt{π} \div 2$$

Δp=differential pressure between the pressure in the outflow area and the pressure in the inflow area
ρ=Density of the conveyed fluid
V=Volume flow of the conveyed fluid.

Such dimensionless speed and/or diameter characteristics result in completely new machines that were not yet known from the state of the art

According to a possible variant of the invention, provision may be made for the volume occupied by the impeller to be at least three times greater than the sum of the passage volumes of the flow passages, and/or for the maximum opening width of the flow outlets or at least some of the flow outlets of the impeller to extend in the circumferential direction across a maximum center-point angle of 10°.

The volume of the impeller is determined from the outer contour of the impeller, wherein internal cavities, for instance recesses or hollow spaces inside the impeller, are not taken into account.

The volume of the impeller is many times greater than the sum of the volumes of the flow passages of the impeller. The compression ratio can be adjusted by adjusting the outer diameter of the impeller. By adapting the flow passages (in terms of their number and cross-section) can be adjusted by the flow rate. In this way, a scalability of the compressor is provided in both relevant dimensions (throughput and pressure ratio).

Preferably, the volume occupied by the impeller can be at least 6 times, preferably at least 8 times, greater than the sum of the passage volumes of the flow passages and/or the maximum opening width of the flow outlets or at least some of the flow outlets of the impeller can extend in the circumferential direction across a maximum center-point angle of 0.5° to 10°, preferably across a maximum center-point angle of 1° to 7°, and/or the maximum opening width of the flow inlets of the flow passages or at least some of the flow inlets of the flow passages of the impeller can extend in the circumferential direction across a maximum center-point angle of 3° to 20°, preferably across a maximum center-point angle of 6° to 14°. These designs are particularly suitable for the effective cleaning of sensor surfaces.

According to a preferred embodiment of the invention, provision may be made for at least some of the flow passages to be designed as circumferentially closed cavities, at least sectionally. Unlike conventional turbo compressors, this solution does not use blades. This solution therefore does not result in a borderline case between the possible blade height and the necessary blade tip clearance. In fact, the cross-sectional area that determines the throughput can be adjusted both by adapting the cross-sectional areas of the cavities and by changing the number of cavities.

A preferred variant of the invention can be such that the size of the flow cross-section of at least some of the flow passages does not change in the direction of the passage length, at least sectionally. This design of impeller is easy to manufacture. Preferably provision may be made for at least some the flow passages in an area between the flow inlet and the flow outlet to have the shape of a cylindrical bore. For instance, the bores can then simply be drilled into an impeller. The bore can extend radially or be inclined in or against the direction of rotation of the impeller.

Within the scope of the invention, it is also conceivable that the size of the flow cross-section of at least some of the flow passages changes in the direction of the passage length, at least sectionally. This can further influence the mass flow rate through the flow passage and, in particular, the pressure ratio generated at a given speed.

Preferably provision may be made for the flow cross-section of at least some of the flow passages to taper outwards in a radial direction in an area between the flow inlet and the flow outlet. This effectively compensates for the increase in the density of the conveyed fluid in the flow passage.

A compressor according to the invention can be such that the flow outlet of at least some of the flow passages is disposed offset with respect to the flow inlet in the circumferential direction and/or in the axial direction. As a result, the flow angle at the flow inlet and the outflow angle at the flow outlet of the impeller can be adjusted to influence the compressor, for instance with regard to operating stability and pressure head. This can be additionally or alternatively improved by a curved course of at least some of the flow passages in the circumferential direction in an area between the flow inlet and the flow outlet.

The impeller can be designed to optimize the installation space with an offset in the axial direction.

If provision is made for at least some of the flow passages to be formed in the area between two interconnected components, then even complicated flow passage courses can be manufactured easily. Particularly preferably provision may be made for one of the components to have a groove extending in the direction of the passage length, which groove delimits the flow passage, and for the other component to complete or cover the groove at least sectionally. The groove can simply be worked into the component in the desired shape, e.g. milled in.

According to a possible variant of the invention, provision may be made for the cross-sectional area of at least one flow passage at the flow inlet and/or at the flow outlet to be at least 0.5 mm² and at most 15 mm², preferably at least 1 mm² and at most 5 mm², to achieve the desired conveying effect.

The problem of the invention is also solved by an assembly, in particular for a land vehicle or a watercraft or an aircraft, having an optical sensor, in particular a lidar sensor, and a compressor according to any of claims 1 to 12, wherein a passage connection is disposed between the impeller and the sensor to route the fluid compressed by the impeller, in particular air, to a surface of the sensor for cleaning purposes.

The invention is explained in greater detail below based on exemplary embodiments shown in the drawings. In the figures,

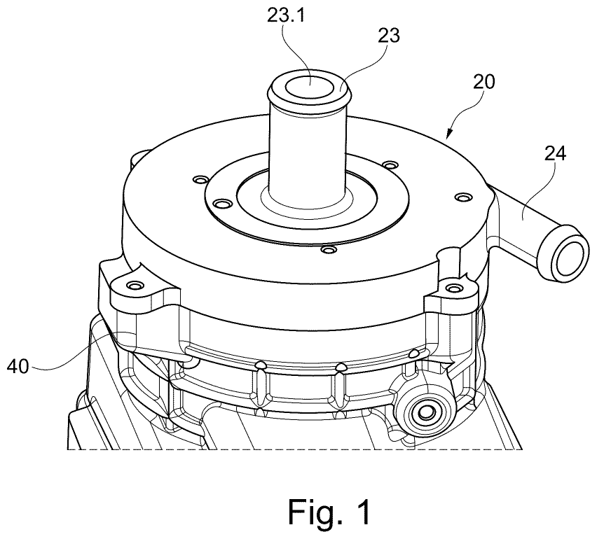

FIG. 1 shows a partial perspective view of a compressor,

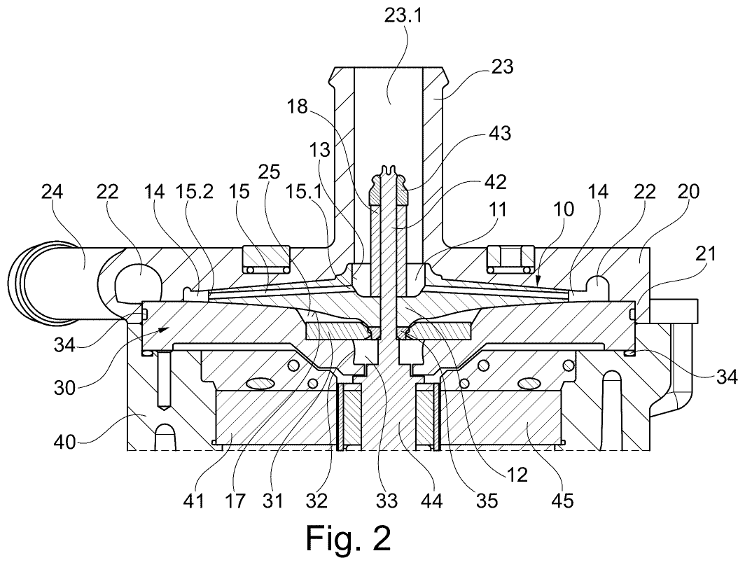

FIG. 2 shows a full section of the compressor of FIG. 1,

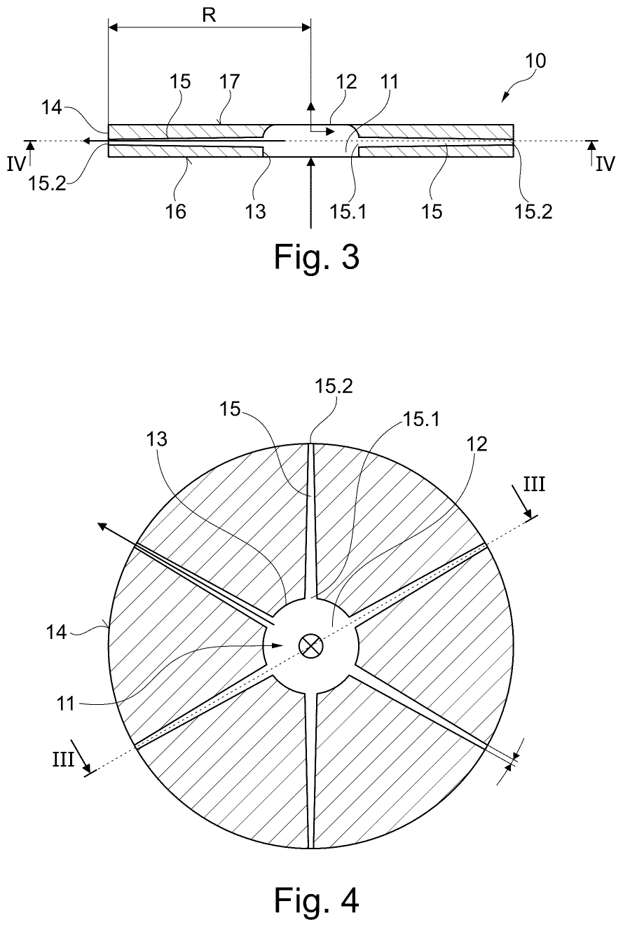

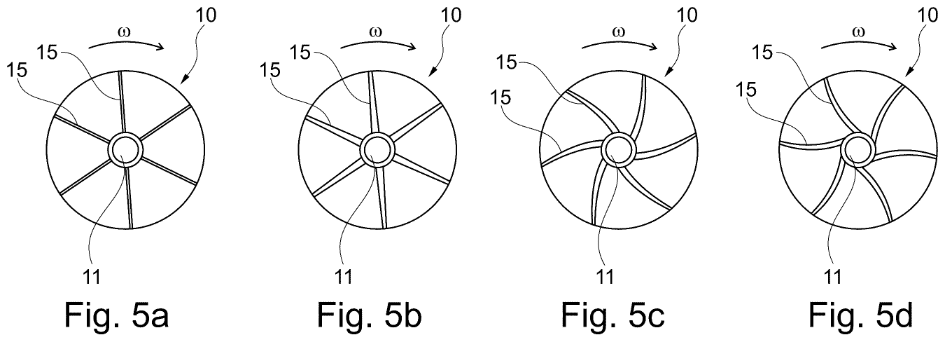

FIG. 3 shows a full section of an impeller for a compressor and along the section marked III-III in FIG. 4,

FIG. 4 shows the impeller of FIG. 3 along the course of the section line marked IV-IV in FIG. 3, and

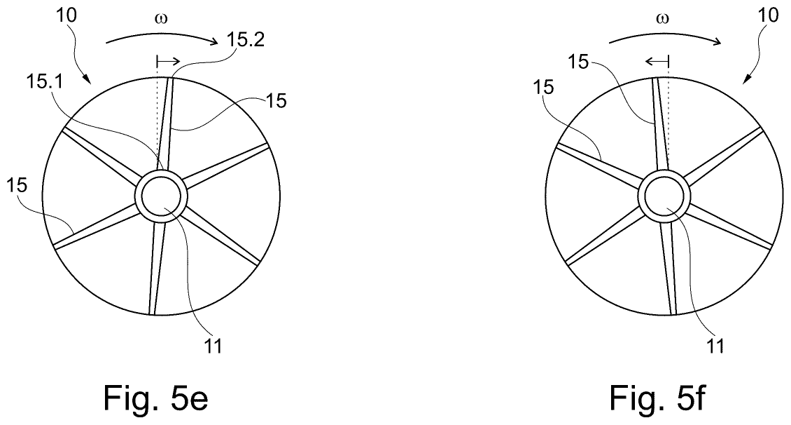

FIGS. 5a-5f show different design variants of impellers.

FIG. 1 shows a compressor that can be used, for instance, in a cleaning system, in which compressed air can be used for cleaning. The cleaning system can be used, for instance, to clean the optical surface of a sensor, in particular a lidar sensor.

FIG. 2 shows the compressor in detail and in full section. As this illustration shows, the compressor has a drive unit, which can be designed as an electric motor 41, for instance. The electric motor 41 has a motor rotor 44, to which a motor stator 45 is assigned. The motor rotor 44 is connected to a drive shaft 42. The drive shaft 42 and the motor rotor 41 can form an integral component. The drive shaft 42 is non-rotatably connected to an impeller 10.

The motor stator 45 of the electric motor 41 is accommodated in a casing having a casing part 40. The casing part 40 can be closed off by means of a bearing part 30. The bearing part 30 has a bearing mount 32, in which a bearing 33 for supporting the drive shaft 42 is mounted. The bearing part 30 is sealed against the casing part 40 (seals 34).

The impeller 10 can preferably be manufactured integrally. However, it is also conceivable that the impeller 10 is designed in several parts, in particular bi-partite.

The impeller 10 has a hub 12, which is used to connect the impeller 10 to the drive shaft 42 for co-rotation. For this purpose, provision may be made for the impeller 10 to be connected, in particular braced, to the drive shaft 42 by means of a nut 43, which is screwed onto a thread of the drive shaft 42. In this exemplary embodiment, a spacer sleeve 18 is disposed between the nut 43 and a supporting surface of the hub 12.

A sealing bush 35 can be disposed between the impeller 10 and the bearing 33, which sealing bush seals the bearing 33 against the flow passage. Furthermore, a support disk 31 can be provided to secure the bearing 33, for instance a ball bearing on its outer ring.

The impeller 10 has a central inflow area 11, which can be incorporated into the impeller 10 in the form of a recess in the area of an inflow end 16. Starting from the inflow area 11, flow passages 15 are formed in the impeller 10 in the form of cavities. In their circumferential direction, the cavities are encompassed on all sides by the geometry of the impeller 10.

The inflow area 11 can be designed such that it is delimited, at least sectionally, by a circumferential inner surface 13. The inner surface 13 has openings in the form of flow inlets 15.1 of the flow passages 15.

The impeller 10 has an outflow area 14 in the area of its outer circumference. Flow outlets 15.2 of the flow passages 15 all open out there.

According to the invention, the flow passages 15 have a flow cross-section that varies or remains constant in the direction of the passage length. Accordingly, the volume of a flow passage 15 is calculated from the passage length and the flow cross-section. The flow passages 15 in the form of cavities in the impeller 10 have a total passage volume. The impeller occupies an impeller volume. According to the invention, the impeller volume is an integer multiple greater than the passage volume. As mentioned above, the impeller volume should be determined by the outer edge of the impeller 10.

The flow passages 15 are disposed spaced apart from one another in the circumferential direction. The angular spacing in the area of the flow outlet 15.2 and or in the area of the flow inlet 15.1 is at least 18°.

FIG. 2 further illustrates that a casing having at least one casing part 20 can be provided, which has or forms a spiral duct 22. This spiral duct 22 opens out into the outflow area 14 on the circumferential end of the impeller 10. The flow outlet 15.2 of the flow passages 15 thus flow into the spiral duct 22.

A compressed-air port 24 is provided downstream of the spiral duct 22, to which compressed-air port a compressed-air line can be connected. The compressed-air port 24 is preferably integrally connected to the casing or the casing part 20. Furthermore, the casing or the casing part 20 may have a connection piece 23 that forms an intake duct 23.1. The intake duct 23.1 is routed towards the inflow area 11. An air supply line can be connected to the connection piece 23 such that the impeller 10 can draw in air via the intake duct 23.1 to the flow inlets 15.1 of the flow passages 15.

FIG. 2 illustrates that the casing part 20 can have a centering mount 21, with which the casing part 20 is aligned with respect to the casing part 40 or with respect to the bearing part 30.

Finally, the casing part 20 may form an impeller mount 25, in which the impeller 10 is at least partially mounted. In this exemplary embodiment, the impeller mount 25 is delimited by the casing part 20 and the casing of the electric motor 41, in this case by the bearing part 30 of the electric motor 41.

According to a preferred variant, the impeller 10 is mounted in an impeller mount 25, which is sealed off from the environment except for the air intake opening (intake duct 23.1) and the exhaust air opening (spiral duct 22). In this exemplary embodiment, seals 34 are provided between the bearing part 30 and the casing part 40 for this purpose.

FIG. 3 shows a possible design variant of an impeller, such as can be used in the compressor shown in FIGS. 1 and 2. As this illustration shows, the impeller 10 has flow passages 15 that extend in the radial direction and are incorporated into the material of the impeller 10 in the form of conical bores. The flow passages 15 taper outwards continuously or discontinuously in a radial direction. It is also conceivable that cylindrical bores could be used for the flow passages 15.

Furthermore, it is also conceivable that flow passages 15 are used, whose flow cross-sections expand continuously or discontinuously along the length of the passage and in the direction of flow, at least in partial areas.

FIGS. 3 and 4 illustrate that the impeller 10 can again have a hub 12, which has an inflow area 11 in the area of an inflow end 16 and can have a drive end 17 opposite from the inflow end 16, for connection to a drive shaft 42, for instance of an electric motor 41. FIG. 3 shows that all flow outlets of the flow passages 15 are spaced equally far apart from the axis of rotation of the impeller 10 by the dimension R, wherein R is preferably the radius of the outer circumference of the impeller 10. The circular area that can be calculated using the radius R is A mm². The flow passages 15 have a minimum flow passage cross-section in the area of the flow outlets. The sum of these minimum flow passage cross-sections of all flow passages 15 of the impeller 10 is B mm². According to the invention:

B/A<0.005.

The outer contour of the impeller 10 occupies a space having a volume. This volume is determined without taking cavities or recesses in the impeller 10 into account. In other words, the volume of the impeller 10 results from the volume surrounding the impeller 10. This volume is at least 3 times larger than the sum of the volumes of the flow passages 15.

FIG. 4 illustrates that the maximum opening width of the flow outlets of the flow passages 15 of the impeller 10 extend across a maximum center-point angle of 10° in the circumferential direction

FIGS. 5a to 5f show different design variants of impellers 10. The design of the impellers 10 in principle matches that of the impellers 10 as described with reference to FIGS. 1-4. To avoid repetition, reference can be made to the explanations above. Only the differences between these impellers are explained below.

The design variants shown in FIGS. 5a to 5f differ in terms of the arrangement and design of their flow passages 15.

FIG. 5a shows an impeller 10 having radially extending flow passages 15, which are designed in the form of cylindrical bores.

FIG. 5b shows an impeller 10 having flow passages 15 that extend radially. The flow cross-sections of these flow passages 15 taper continuously in the radial direction outwards along the length of the passage.

FIGS. 5c and 5d show impellers 10 having flow passages 15 that are curved along the length of the passage. To this end, according to FIG. 5c, flow passages 15 are provided which are curved in the opposite direction to the direction of rotation ω. FIG. 5b shows flow passages 15 that are curved in the direction of rotation ω.

The flow passages 15 also have areas that are curved both in and against the direction of rotation ω. It is also conceivable that the flow passages 15 have a constant flow cross-section or a varying flow cross-section along their passage length.

FIGS. 5e and 5f illustrate that, within the scope of the invention, the flow passages 15 can be designed such that the flow inlet 15.1 is disposed offset in relation to the flow outlet 15.2 in the direction of rotation ω. This feature can be implemented in all impellers 10 according to the invention, in particular in the impellers according to FIGS. 5a to 5d.

The flow inlet 15.1 may be set back relative to the flow outlet 15.2 in the direction of rotation ω (5e) or the flow outlet 15.1 may be set back relative to the flow inlet 15.2 in the direction of rotation ω (FIG. 5 f).

1-14. (canceled)

15: A compressor, comprising:
a rotatably mounted impeller including a radially inner inflow area and a radially outer outflow area, the inflow area being connected to the outflow area by a plurality of flow passages extending from the inflow area to the outflow area, each flow passage forming a flow outlet in the outflow area and a flow inlet in the inflow area, each flow passage having a passage length extending from the inflow area to the outflow area, each flow passage having a flow cross-section extending in a circumferential direction of the impeller and each flow passage having a minimum flow cross-section along its respective passage length;
wherein the impeller has an axis of rotation, and a distance of one of the flow outlets spaced furthest from the axis of rotation forms a radius for calculating a circular area; and
wherein a sum of the minimum flow cross-sections of all of the flow passages is less than 0.01 times the circular area.

16: The compressor of claim 15, wherein:
the sum of the minimum flow cross-sections of all of the flow passages is less than 0.008 times the circular area.

17: The compressor of claim 15, wherein:
the impeller occupies an impeller volume;
each flow passage has a passage volume; and
the impeller volume is at least three times greater than a sum of the passage volumes of all of the flow passages.

18: The compressor of claim 17, wherein:
the impeller volume is at least six times greater than the sum of the passage volumes of all of the flow passages.

19: The compressor of claim 17, wherein:
the impeller volume is at least eight times greater than the sum of the passage volumes of all of the flow passages.

20: The compressor of claim 15, wherein:
a maximum opening width of at least some of the flow outlets extends in a circumferential direction of the impeller over a maximum center-point angle no greater than 10°.

21: The compressor of claim 15, wherein:
at least some of the flow passages are at least in part circumferentially closed cavities.

22: The compressor of claim 15, wherein:
the flow cross-section of at least some of the flow passages does not change along the passage length.

23: The compressor of claim 15, wherein:
at least some of the flow passages are shaped as cylindrical bores.

24: The compressor of claim 15, wherein:
the flow cross-section of at least some of the flow passages changes along the passage length.

25: The compressor of claim 15, wherein:
the flow cross-section of at least some of the flow passages tapers in a radially outward direction along the passage length.

26: The compressor of claim 15, wherein:
the flow outlets of at least some of the flow passages are offset from the flow inlets of the respective passages in a circumferential direction of the impeller.

27: The compressor of claim 15, wherein:
the flow outlets of at least some of the flow passages are offset from the flow inlets of the respective flow passages in an axial direction of the impeller.

28: The compressor of claim 15, wherein:
at least some of the flow passages are curved in a circumferential direction of the impeller between the flow inlets and the flow outlets of the respective flow passages.

29: The compressor of claim 15, wherein:
at least some of the flow passages are formed between two interconnected components of the impeller, one of the two interconnected components having a groove formed along the passage length, and the other of the two interconnected components covering the groove.

30: The compressor of claim 15, wherein:
the impeller includes a centric recess in an area of the axis of rotation, and the centric recess is in fluid-conveying connection with the flow inlets of the flow passages in the inflow area.

31: The compressor of claim 15, wherein:
the flow cross-section of at least one of the flow passages at the flow outlet is in a range of from 0.5 mm² to 15 mm².

32: The compressor of claim 15, further comprising:
a casing including a spiral duct communicated with an outer circumference of the impeller such that the flow passages open out into the spiral duct.

33: The compressor of claim 15, further comprising:
a drive coupled to the impeller by a drive shaft.

34: The compressor of claim 15, in assembly with a vehicle or a watercraft or an aircraft including a lidar sensor, wherein a passage connects the impeller and the sensor to route compressed air generated by the impeller to a surface of the sensor to clean the surface of the sensor.
